(19) United States
(12) Patent Application Publication
(10) Pub. No.: US 2005/0143889 A1
(43) Pub. Date: Jun. 30, 2005

(54) Vehicle driving assistance apparatus and method

(75) Inventors: Kazuyoshi Isaji, Kariya-city (JP); Naohiko Tsuru, Handa-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 10/990,398

(22) Filed: Nov. 18, 2004

(30) Foreign Application Priority Data
Dec. 24, 2003 (JP) 2003-427820

(51) Int. Cl. G06F 7/70

(52) U.S. Cl. 701/70; 701/80; 701/300

(57) ABSTRACT

A driving assistance apparatus assists turning operation of a vehicle at an intersection by taking critical variables into account. The apparatus first estimates friction coefficient of a road to determine a suitable acceleration in turning, and then calculates a required period of time to finish turning by using other variables such as a width of the road derived by one of the functions of the apparatus. Based on the comparison with the time that the oncoming vehicle in the opposite lane will take to arrive at the intersection and the required time for turning, driving assistance for the vehicle to turn safely at the intersection can be appropriately provided.

### CROSS REFERENCE TO RELATED APPLICATION

This application is based on and incorporates herein by reference Japanese Patent Application No. 2003-427820 filed on Dec. 24, 2003.

### TECHNICAL FIELD OF THE INVENTION

The present invention relates to a vehicle driving assistance apparatus and method that assists driver's operation in an attempt of turning at an intersection in order to avoid a collision with an oncoming vehicle in the opposite lane.

### BACKGROUND OF THE INVENTION

JP-A-9-270097 discloses a vehicle driving assistance apparatus that conveys the condition of an oncoming and going-through vehicle securely and correctly to a driver of the vehicle and helps the driver's judgment of turning (when to start turning).

This driving assistance apparatus has an image sensor that outputs the image of going-through vehicles approaching to an intersection, an operation unit that uses signal status from a signal controller and an image signal from the image sensor to calculate when-to-turn information, and a transmitter that sends the image signal and when-to-turn information to the vehicle, all installed on the roadside. Also, the vehicle has a receiver that receives the image signal and the when-to-turn information sent out from the transmitter, a display device that displays the received image and information. By using this apparatus, the driver of the vehicle utilizes the image of the through-traffic and when-to-turn information on the vehicle and determines an appropriate timing to turn.

The period of time for turning (from start turning to finish turning) at an intersection varies depending on the conditions. For example, on the road with low friction (μ), the vehicle has to start gradually, thus it takes longer to finish turning compared to the road with high friction (μ), such as a dry asphalt road. Moreover, on the road with multiple lanes, it will take longer than the road with a single lane to finish turning.

### SUMMARY OF THE INVENTION

The present invention addresses the foregoing shortcomings in a vehicle driving assistance apparatus and method. That is, a vehicle driving assistance apparatus and method of the present invention takes those variable factors into account to provide an appropriate assistance for turning against through-traffic at an intersection.

To achieve the above object, the driving assistance apparatus estimates a friction coefficient, acquire other vehicle data, and calculate a turning time.

The apparatus basically collects data on other oncoming vehicle by using a CCD camera and data regarding the road to be crossed by using a navigation system. Based on the environmental information, the apparatus calculates the turning time on the current condition of the surface of the road. When determining an acceleration of the vehicle, the apparatus takes various conditions of the road surface into accounts, thus can precisely calculates the time for traversing the intersection.

The apparatus, then compares the arriving time of the oncoming vehicle and the turning time of the vehicle, to either give out warning to the driver of the vehicle to warn the possibility of collision, or to control the vehicle to limit the acceleration by applying a braking force, or to give notice to the driver to start turning for the assurance of safety of turning.

Further, the apparatus acquires an accurate distance of the width of the road, and stores the data from the navigation system such as the position of the intersection and the number of the lanes of the thru traffic. Data of the other vehicle (speed, position, and the like) can be captured by using either a CCD camera or a radar to be used in turning time calculation. All the necessary data can be acquired on the vehicle, and hence no assisting devices are required to be installed on the roadside of the intersection.

In the description of the drawing section and the embodiment section, turning at an intersection is specified as right turn. This is because of the traffic environment of Japan where the inventor of this invention resides. However, the scope of the present invention is not limited only to right turn of a vehicle. That is, the driving assistance apparatus of the present invention can be used in the United States of America if the turning direction and the related functionalities are adapted to the traffic environment of the United States of America.

### BRIEF DESCRIPTION OF THE DRAWINGS

While the appended claims set forth the features of the present invention with particularity, the invention together with its objects and advantages, may be best understood from the following detailed description taken in conjunction with the accompanying drawings, in which:

FIG. 1 shows a block diagram of a vehicle driving assistance apparatus related to this embodiment;

FIG. 2 shows a flow chart of driving assistance control for turning-right that is executed while a vehicle is waiting at an intersection for a chance of turning-right; and

FIG. 3 shows a birds-eye view of an intersection to describe the situation regarding turning-right.

### DETAILED DESCRIPTION OF THE PREFERRED EMBODIMENTS

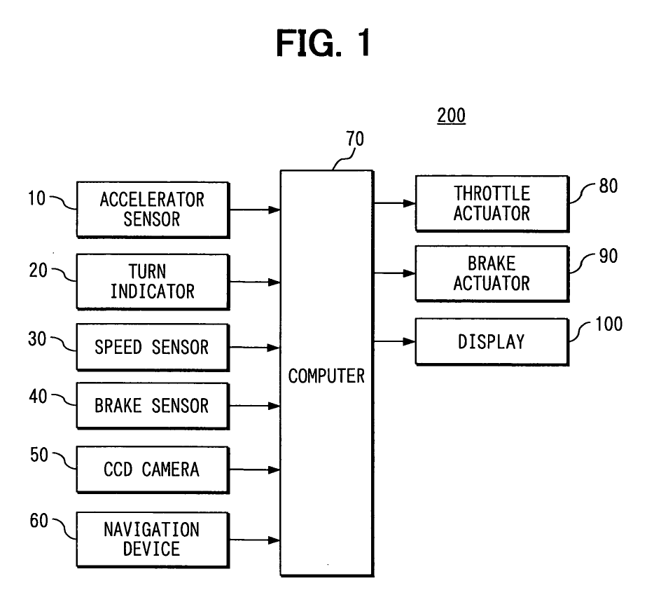

According to FIG. 1, a vehicle driving assistance apparatus 200 is comprised of an accelerator sensor 10, a turn indicator 20, a speed sensor 30, a brake sensor 40, a CCD camera 50, and a navigation system 60. Those are connected to a computer 70.

The driving assistance apparatus 200 also is comprised of a throttle actuator 80, a brake actuator 90, and a display 100. Those are also connected to the computer 70, and driven by control signals from the computer 70.

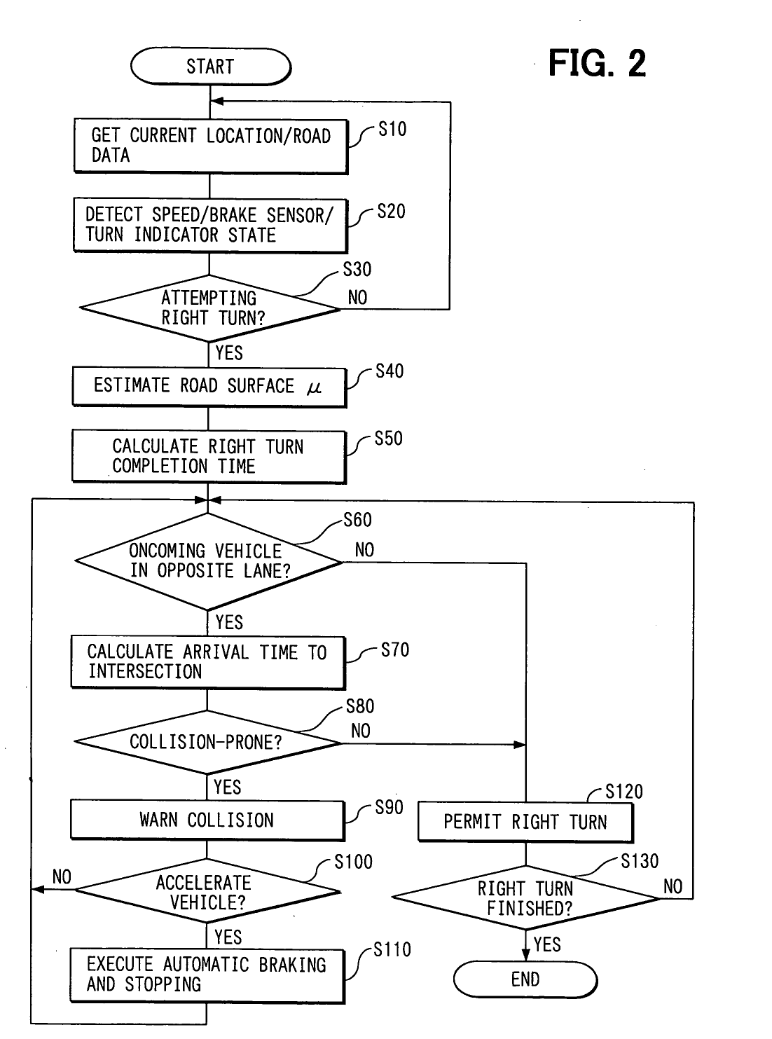

The computer 70 has a CPU, a ROM, a RAM and other input/output interfaces (I/O). The computer 70 also has various driving circuits in it. However, this type of hardware structure is very common, and thus the detailed description is not included. This computer 70 determines the existence of an oncoming vehicle in the opposite lane when the vehicle is waiting to turn at an intersection, and calculates an arriving time of the oncoming vehicle to the intersection. Then, by comparing the period of time for the vehicle to finish turning and the arriving time of the oncoming vehicle, the computer 70 determines whether the vehicle should start turning and assists driving operation accordingly. The actual steps of driving assistance are described in detail later in the flow chart shown in FIG. 2.

The accelerator sensor 10 detects an operation of accelerator pedal (On/Off) by a driver. The accelerator pedal operation signal is utilized in the computer 70 to determine whether the vehicle started to turn.

The turn indicators 20 are used to indicate tuning intention of the driver of the vehicle to the surrounding vehicles when the vehicle starts to turn. The turn indicator operation signal is utilized in the computer 70 to determine whether the vehicle is going to turn right at the intersection.

The speed sensor 30 is, for example, disposed in the proximity of axle and outputs the speed signal based on the rotation speed of the wheel. The speed signal is utilized in the computer 70 to calculate the speed of the vehicle and thus to determine the waiting state (a temporary stopping state) at the intersection in an attempt for turning right, and is also utilized to calculate the distance to complete the turning.

The brake sensor 40 detects an operation (On/Off) of the brake pedal by the driver. The brake pedal operation signal is utilized in the computer 70 to determine a waiting state at the intersection, or starting of turning right.

The CCD camera 50 is, for example, disposed at the backside of a room mirror and is used to capture the predetermined area in front of the vehicle, and converts the captured image into electric image signals to be output to the computer 70. In the present embodiment, the existence of an oncoming behicle in the opposite lane, and the distance from the oncoming vehicle, if any, to the intersection and the speed, is calculated based on the image signals derived from the CCD camera 50. Further, the computer 70 determines the surface condition of the road in front of the vehicle based on the image signal derived from the CCD camera 50, and estimates the friction coefficient of the road (road surface friction coefficient). The method to estimate the road surface friction coefficient is described later in detail.

The navigation system 60 is, as may well known in general, the device that has a various navigation function, such as a map display function to display the map around the vehicle based on the detected position of the vehicle, a nearby facility search function to pickup nearby facilities, and a route guide function to find a route to the destination.

This navigation system 60 comprises, a position detection device, a map data input device, a VICS receiver, navigation ECU and the like, all not in shown in FIGS. Among them, the position detection device comprises a terrestrial magnetism sensor, a gyroscope, a distance sensor, and a GPS receiver for GPS (Global Positioning System) that determines the position of the vehicle based on the radio wave from the satellites. Because each of these devices has its own types of errors, the navigation system 60 is constructed to cancel those errors by each other. Further, the position detection device may be constructed from a portion of the devices described above depending on the accuracy of the devices.

The map data input device is the one that is used to input map data into the navigation ECU. For the media to record the map data, CD-ROMs and DVD-ROMs are usually used because of its capacity, but a writable medium such as a memory card and a hard disk and the like may also be used.

The map data (road data) is mainly made up of the link data and the node data. The links in the link data are defined as the links between the nodes of the each road such as intersections, branches, meeting points and the like. The link data includes a specific ID to identifies each link, a link length to indicates the length of the link, node coordinates of the start/end points (latitude and longitude) of the link, a name of the road, the width of the road and the like.

Moreover, the node data includes a specific node ID that is attached to an intersection, a meeting point, and a branch, node coordinates, a node name, connected link IDs, types of intersection and the like.

The VICS receiver receives road information delivered from the VICS (Vehicle Information and Communication System) center by using beacons at the roadsides and FM station of various locations. This road information includes, for example, traffic jam information such as the section of a traffic jam, magnitude of the traffic jam and the like, and traffic regulation information such as a closure of a road.

This navigation system 60 delivers the road information such as the current position of the vehicle and the corresponding road data to the computer 70. The computer 70 determines whether the vehicle entering into the intersection based on the current position of the vehicle and the road data. Further, the navigation system 60 may be constructed to yield a data that indicates the entrance of the vehicle into the intersection.

Furthermore, the road information including the width of the road in the link data is delivered from the navigation system 60. The computer 70 calculates the distance to complete the turning based on the width attribute of the road data.

The throttle actuator 80, the brake actuator 90, and the display 100 are driven based on the control signal from the computer 70. The throttle actuator 80 controls the opening degree of the throttle (not shown in FIGS.) to control the output of the internal combustion engine. The brake actuator 90 controls the brake pressure to control the braking force of the vehicle.

The display 100 informs the safety of turning to the driver when there is no oncoming vehicle in the opposite lane and when there is no possibility of collision in spite of the existence of an oncoming vehicle. On the other hand, the display 100 informs warning to the driver of the vehicle that the vehicle should wait for another chance of turning when there seems to be a possibility of collision with the oncoming vehicle if the vehicle now starts turning.

Next, the road surface friction coefficient estimation method and execution of the driving assistance controls when the vehicle at an intersection is waiting for turning (right), are described in detail based on the flow chart shown in FIG. 2.

In the flow chart in FIG. 2, the current position of the vehicle and the corresponding road data is acquired from the navigation system 60 in step S10 in the first place. Then, in step S20, the speed of the vehicle calculated based on the speed signal from the speed sensor 30, detected signal from the brake sensor 40, and the operation signal from the turn indicators 20 are collected respectively.

In step S30, the condition of the vehicle is determined if it is waiting for turning or not. It is determined as the waiting condition, when the current position of the vehicle derived from the navigation system 60 belongs to the category of intersection, the speed of the vehicle is under a certain level as it can be regarded as stopping, the brake is on (the brake pedal is pushed down), and the turn indicator operation signal indicates signaling of right turn.

Further, when the vehicle is entering into the parking space or the like on the opposite side of the road, the vehicle also turns to the right and traverses the opposite lanes. This means that, when the condition about the speed, the brake, and the turn indicators 20 are fulfilled, the vehicle can be regarded as a waiting for right turn condition in the places other than the intersection. The waiting for right turn condition can also be determined by either of the speed or the operation of the brake pedal.

When the vehicle is determined not in the waiting for right turn condition in step S30, process of the flow chart returns to step S10, and when it is determined in the waiting condition, process of the flow chart proceeds to step S40. In step S40, the road surface friction coefficient is estimated based on the image signal derived from the CCD camera 50. That is, the image of the road in front of the vehicle captured by the CCD camera 50 is used to determine the surface condition of the road (for example, dry, wet, and the like), and the road surface friction coefficient corresponding to the determined condition can be identified in the predetermined table of conversion. Determination of the road surface condition and conversion from the specific condition of the road to the road surface friction coefficient are described in detail in the following section.

When the road surface condition is determined based on the image of the road captured by the CCD camera 50, the brightness of each pixel of the image of the road is identified, and the average brightness of the road is then calculated. The average brightness is compared to the predetermined threshold of brightness to determine that the road is wet when the average brightness is above the threshold and the road is dry when the average is below the threshold.

Multiple thresholds can be prepared to accommodate the road surface condition such as hydroplaning, frozen, and accumulated snow. Different methods of determining the road surface condition are proposed conventionally, and the method may not necessarily be limited to the one using the image of the CCD camera 50 used in the present embodiment, but the conventional method can also be used.

The road surface friction coefficient is identified based on the condition of the road surface that is correlated to a conversion table. For example, the conversion table correlates road surface friction coefficient to 0.8 when the road condition is dry. The road surface friction coefficient can be picked up according to the method described above based on the road condition.

Further, method of the road surface friction coefficient estimation is not necessarily limited to the above-described one. For example, the weather information, the road position information, the weather condition information derived from the vehicle attached sensors, the road surface information that is manually inputted by the driver, and the information derived from test braking can be utilized to estimate the road surface friction coefficient. Preferably, the wheel speed decreasing rate, or the vehicle speed decreasing rate when braking operation is taken place, are correlated to the road surface friction coefficient by using an internal map to pick up the road surface friction coefficient of the current condition.

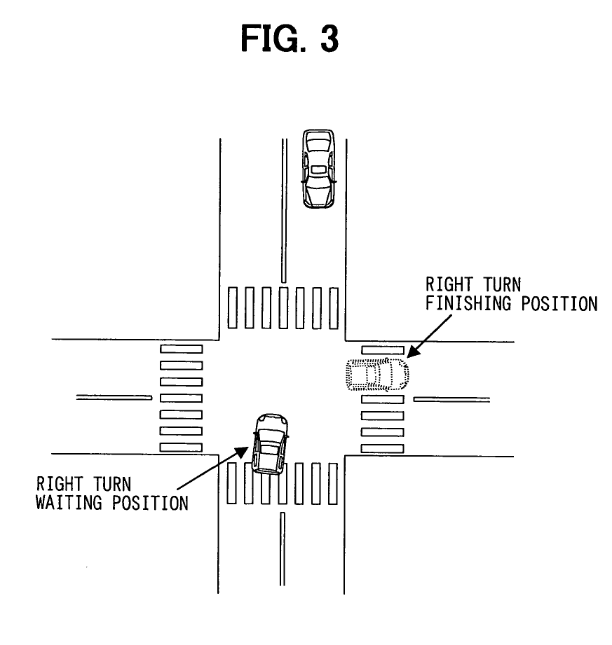

In step S50, the period of time from the start of right turn to the end of turning is calculated. That is, as shown in FIG. 3, the elapsed time that starts when the vehicle started right turn at the waiting position in an intersection, and ends when the vehicle reaches the right turn completion position just outside of the intersection is measured. In calculating the elapsed time for right turn, the distance to be run to reach the right turn completion position is calculated first based on the road data and the width of the road data. For example, the distance to finish right turn can be calculated as approximately one fourth of the periphery of a circle that has the same diameter as the width of the road.

However, the distance to finish right turn can also be derived from the image in front of the vehicle captured by the CCD camera 50. When utilizing the image of the CCD camera, the right turn complete position is determined in the image signal, and the curved distance to that point is regarded as the required distance.

After calculating the distance for right turn in the above described way, the elapsed time from starting of right turn with the speed of zero to ending of right turn in the acceleration according to the road surface friction coefficient is calculated. The acceleration according to the road surface friction coefficient is predetermined by experiments or the like and memorized, and the acceleration value increases when value of the road surface friction coefficient increases, as might be expected. The right turning time can be calculated in this way.

Further, the correlation between the road surface friction coefficient and the acceleration may either be continuous or graded. Also, the right turning time of the vehicle may be calculated, for example, based on the high friction coefficient value and corresponding acceleration, with the adjustment by the detected road surface friction coefficient to add correction value to the initially calculated value of turning time. Though various methods can be adopted to accommodate the changing condition of the road surface, the right turning time is variably changed, to be shorter for the dry surface or to be longer for the wet surface.

In step S60, oncoming vehicle in the image signal captured by the CCD camera 50 is identified and whether the oncoming vehicle is within the predetermined distance from the intersection or not is determined. When the oncoming vehicle is determined as being within the predetermined distance from the intersection, the process in step S70 calculates the time to be taken by the vehicle to reach the intersection. That is, the image signal derived from the CCD camera 50 is utilized to calculate the distance from the oncoming vehicle to the intersection and the speed of it. The arrival time of the oncoming vehicle to the intersection can then be calculated based on the distance and the speed calculated above.

In step S80, the period of time to finish right turning and the arrival time of the oncoming vehicle are used to determine whether there is a possibility of collision between the vehicle and the oncoming vehicle. For example, the right turning time of the vehicle with a certain spare time is compared with the arrival time of the oncoming vehicle to the intersection, and when the arrival time of the oncoming vehicle is shorter, the apparatus determines that the collision is possible, and when the arrival time is longer, the apparatus determines there is no possibility of collision.

When a possibility of collision is determined in step S80, the process proceeds to step S90, and a warning to inform the possibility of collision with the oncoming vehicle in the opposite lane is executed. This warning is executed in the form of a warning voice, a warning sound, or the warning display on the display of the navigation system 60.

In step 100, the condition of the vehicle, whether it started turning in spite of the warning process without keeping waiting state, is determined based on the detected signal of accelerator sensor 10. Preferably, whether the vehicle started turning is determined when the following conditions are fulfilled, that is, the detected signal of the brake sensor 40 is negatively confirmed that the brake pedal is off, and the acceleration pedal is on.

When the vehicle is determined to start turning in step S110, the control signal is outputted to the brake actuators 90 to automatically apply stopping force to stop the vehicle.

When this controlled stopping is executed, the control signal may be directed to the throttle actuator 80 instead of the brake actuator 90 to limit the opening degree of the throttle valve to the opening side, or to force the valve to the position of closure. Further, the control signal may be outputted to the throttle actuator 80 and the brake actuator 90 at the same time.

Further, when the throttle valve is controlled not to open wider, an increase of the speed of the vehicle is suppressed, and when the throttle valve is forced to shut, the speed of the vehicle is decreased. The method described above can at least suppress the increase of the vehicle speed and thus shifts the timing of the vehicle to traverse the intersection to prevent a collision with an oncoming vehicle.

When the vehicle is determined to be waiting in step S100, or after automatic braking process is executed in step S110, the process returns to step S60 and repeats to determine whether an oncoming vehicle exists in the opposite lane. When the oncoming vehicle passes through the intersection and no following vehicle exists, the determination result in step S60 is “No.” When a following vehicle exists but still far from the intersection and have long time to reach the intersection, the determination result in step 80 is “No.”

When determined as “No” in step S60 or step S80, the process proceeds to step S120 and a control signal that permits right turn is outputted to the display 100.

Then, in step S130, the distance from the start of right turn is calculated based on the speed derived from the speed signal, and this traveled distance is compared with the right turn completion distance. When the traveled distance is determined over the right turn completion distance, right turning is regarded as complete, and the driving assistance control according to this embodiment finishes. When the traveled distance is under the right turn completion distance, the process returns to the step S60 (Oncoming vehicle watch). However, the vehicle had already started turning and in the middle of traversing the opposite lane, the apparatus may be constructed only to inform the driver to quickly finish the right turn.

As described above, because the apparatus calculates the right turn completion time based on road surface friction coefficient of the currently running road and the right turn completion distance in the present embodiment, the right turn completion time is as accurate as it can be. As a result, with the comparison to the arrival time of the oncoming vehicle, the apparatus can appropriately assist driving of a vehicle when vehicle is turning right at an intersection.

Further, the surface condition of the road can be derived from the weather surrounding the vehicle and the road. Also, by taking the weather into consideration using a certain method, the apparatus can simplify the determining process of the friction coefficient of the road, resulting in the wider application and usage of the apparatus. For example, when it snows in the area surrounding the vehicle in question, the condition for turning can simply be considered as slippery than normal road surface condition, and thus additional cautious consideration may be incorporated to the determination of turning permission by the apparatus.

Furthermore, a pedestrian or a vehicle like bicycle around the finishing position of turning has to be secured at the same time. By taking all moving objects into account, this object can also be achieved.

The present invention should not be limited to the embodiment previously discussed and shown in the figures, but may be implemented in various ways without departing from the spirit of the invention.

For example, in the embodiment described above, the distance from the oncoming vehicle to the intersection and the speed of the oncoming vehicle is calculated based on the image signal derived from the CCD camera 50. However, the distance to the oncoming vehicle and the speed of it may be, for example, calculated by using a radar device utilizing laser or millimetric-wave.

Furthermore, the position of the oncoming vehicle (distance to the intersection), the speed data of the oncoming vehicle, the right turn completion distance, and the like may be acquired, at each intersection, from a roadside apparatus that detects and stores those data with a communication means.

1. A driving assistance apparatus comprising:
a means for estimating friction coefficient of a road that is currently being run by a vehicle;
a means for acquiring other vehicle data that includes existence of an oncoming vehicle in an opposite lane, and an arrival time of the oncoming vehicle to an intersection when the vehicle is waiting to turn;
a means for calculating a period of time for the vehicle to finish turning at the intersection, with a variable of estimated friction coefficient of the road; and
a means for assisting driving based on the other vehicle data and the period of time for the vehicle to finish turning.

2. The driving assistance apparatus of claim 1, wherein the assisting means includes a means for warning as a driving assistance a possibility of collision between the vehicle and the oncoming vehicle is determined based on the other vehicle data and the period of time for the vehicle to finish turning.

3. The driving assistance apparatus of claim 1, wherein the assisting means executes either one or both of the following controls over the vehicle as a driving assistance, that is, a control over speed increase of the vehicle and applying braking force, when a possibility of collision between the vehicle and the oncoming vehicle is detected based on the other vehicle data and the period of time for the vehicle to finish turning.

4. The driving assistance apparatus of claim 1, wherein the assisting means gives out a notice that informs a driver of safety of turning, when no possibility of collision between the vehicle and the oncoming vehicle is determined based on the other vehicle data and the period of time for the vehicle to finish turning.

5. The driving assistance apparatus of claim 1, further comprising:
a means for acquiring a distance of turning at the intersection; and
the means for calculating the period of time for the vehicle to finish turning variably calculates a required time for turning at the intersection based on the distance of turning at the intersection.

6. The driving assistance apparatus of claim 5, wherein the means for acquiring a distance of turning at the intersection has a memorizing means to memorize a road data with its width, and a position detection means to pick up a current position of the vehicle, to calculate a distance of turning by using the road data with its width at the current position.

7. The driving assistance apparatus of claim 1, wherein the means for acquiring other vehicle data is either an image processing means that calculates a position and an arrival time of the oncoming vehicle from a captured image, or a radar processing means that calculates a position and an arrival time of the oncoming vehicle from a result of radar signal transmission/reception.

8. A vehicle driving assistance method to turn on a road, the method comprising the steps of:
acquiring information of a road and location of a vehicle;
determining surface condition of the road;
calculating time required to finish turning based on the acquired information and the surface condition when the vehicle is in the condition for turning;
determining whether and when a moving object in an opposite lane of the road arrives at the location;
determining a possibility of collision by comparing the arrival time of the moving object and the required time for the vehicle to finish turning; and
assisting a driver of the vehicle when the possibility of collision is determined.

9. The vehicle driving assistance method of claim 8, wherein the step of assisting includes the step of automatically applying a stopping force to the vehicle when the vehicle is moved.

10. The vehicle driving assistance method of claim 8, wherein the step of assisting includes the step of informing the driver of the possibility of collision.
